(19) United States
(12) Patent Application Publication
(10) Pub. No.: US 2014/0203889 A1
(43) Pub. Date: Jul. 24, 2014

(54) POWER DIVIDER

(71) Applicants: Gareth Michael Lewis, Chelmsford-Essex (GB); Richard Stanley Orton, Chelmsford-Essex (GB)

(72) Inventors: Gareth Michael Lewis, Chelmsford-Essex (GB); Richard Stanley Orton, Chelmsford-Essex (GB)

(73) Assignee: BAE SYSTEMS PLC, London (GB)

(21) Appl. No.: 14/238,641

(22) PCT Filed: Aug. 13, 2012
(86) PCT No.: PCT/GB2012/051966

§ 371 Date: Feb. 12, 2014

(30) Foreign Application Priority Data
Aug. 16, 2011 (GB) 1114067.0

(51) Int. Cl. H01P 5/12

(52) U.S. Cl. CPC H01P 5/16
USPC 333/136; 333/127

(57) ABSTRACT

A power divider/combiner comprising a plurality of transmission lines, each transmission line being in the form of a separate longitudinal component (e.g. a length of coaxial cable), wherein the longitudinal components are arranged such that they are substantially parallel to each other, and such that a side of each longitudinal component is contiguous with a side of at least one other longitudinal component. Each of the transmission lines may be of substantially the same length. The length of a transmission lines may be substantially equal to a quarter of the wavelength of an input signal for the power divider/combiner.

### FIELD OF THE INVENTION

The present invention relates to power dividers, power combiners/couplers, and the like.

### BACKGROUND

Power dividers and power combiners are used in many fields, such as radio technology and microwave technology. For example, a Wilkinson power divider may be used to divide an input power between a number of outputs whilst achieving isolation between the output ports and maintaining a matched condition on all ports.

However, conventional power dividers tend to be planar devices, i.e. they are produced such that the components of the power divider are in a common plane. For example, the components of a conventional power divider may be arranged on a surface of a planar substrate. Thus, conventional power dividers tend to occupy a relatively large space or volume.

### SUMMARY OF THE INVENTION

In a first aspect, the present invention provides a power divider/combiner comprising a plurality of transmission lines, each transmission line being in the form of a separate longitudinal component, wherein the longitudinal components are arranged such that they are substantially parallel to each other, and such that a side of each longitudinal component is contiguous with a side of at least one other longitudinal component.

Each of the transmission lines may be of substantially the same length.

The length of a transmission lines may be substantially equal to a quarter of the wavelength of an input signal for the power divider.

The longitudinal components may be arranged such that: one end of each of the longitudinal components is aligned with substantially the same point along a longitudinal axis of the power divider/coupler, and each of the longitudinal components extends in the same direction along the longitudinal axis of the power divider/coupler from that point.

A longitudinal component may be a length of coaxial cable.

The power divider/combiner may be a Wilkinson power divider/coupler.

The power divider/combiner may be a multistage power divider/coupler.

The longitudinal components are arranged such that: a direction of travel of a signal through each of the longitudinal components of one stage of the power divider is substantially the same, and the direction of travel of a signal through each of the longitudinal components of one stage of the power divider is opposite to the direction of travel of the signal through the longitudinal components of a directly preceding and/or directly subsequent stage.

The power divider/combiner may further comprise a further longitudinal component, wherein the longitudinal components and the further longitudinal component are arranged such that: the direction of travel of a signal through the further longitudinal component is opposite to the direction of travel of the signal through the longitudinal components of a directly subsequent stage of the power divider.

A side of each longitudinal component may be contiguous with a side of the further longitudinal component.

The further longitudinal component may be longer than each of the longitudinal components.

The further longitudinal component may be a length of coaxial cable.

An input of power divider/combiner may be relatively proximate to one end of each of the longitudinal components, and an output of power divider/combiner may be relatively proximate to another end of each of the longitudinal components that is opposite to the end of the longitudinal components that the input is relatively proximate to.

### BRIEF DESCRIPTION OF THE DRAWINGS

FIG. 1 is a schematic circuit diagram (not to scale) of an embodiment of a power divider;

FIG. 2 is a schematic illustration (not to scale) of a perspective view of the power divider;

FIG. 3 is a schematic illustration (not to scale) of a top view of the power divider;

FIG. 4 is a schematic illustration (not to scale) of a bottom view of the power divider; and

FIG. 5 is a schematic circuit diagram (not to scale) of a further power divider.

### DETAILED DESCRIPTION

In the following description, terminology such as “top”, “bottom”, “up”, “down” etc. is adopted to describe elements of the invention. It will be appreciated by the skilled person that such terminology is not limiting and is used merely to refer to the position/orientation of one element relative to other elements.

Also, in the following description, it will be appreciated by the skilled person that the terminology “power divider” is not limiting and may refer to power dividers, power combiners, directional couplers, and the like.

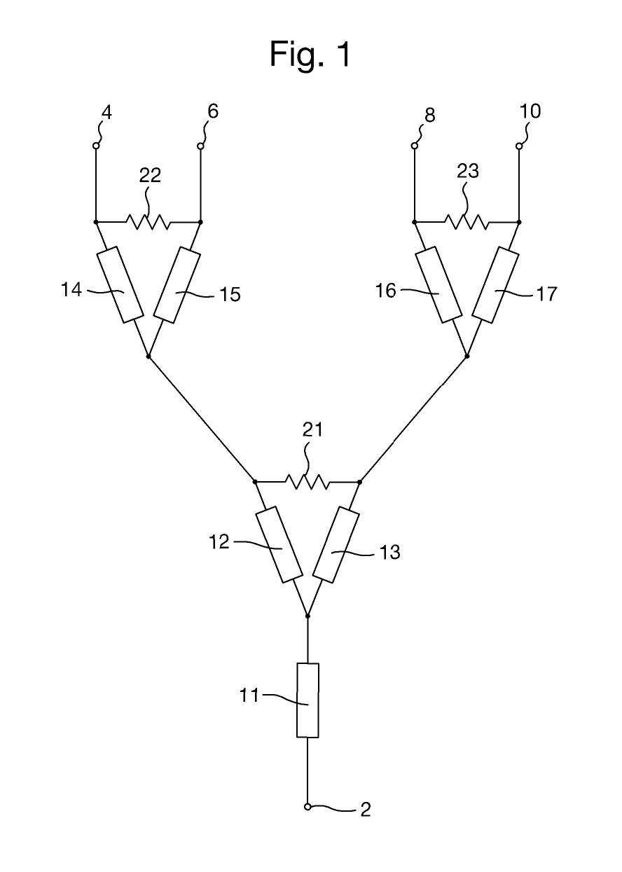

FIG. 1 is a schematic circuit diagram (not to scale) of an embodiment of an equal-amplitude, four-way split, two-stage Wilkinson power divider, hereinafter referred to as “the power divider 1”.

In this embodiment, the power divider 1 comprises an input port 2, a first output port 4, a second output port 6, a third output port 8, a fourth output port 10, a first length of transmission line (hereinafter referred to as the “first transmission line 11), a second length of transmission line (hereinafter referred to as the “second transmission line 12), a third length of transmission line (hereinafter referred to as the “third transmission line 13), a fourth length of transmission line (hereinafter referred to as the “fourth transmission line 14), a fifth length of transmission line (hereinafter referred to as the “fifth transmission line 15), a sixth length of transmission line (hereinafter referred to as the “sixth transmission line 16), a seventh length of transmission line (hereinafter referred to as the “seventh transmission line 17), a first resistor 21, a second resister 22, and a third resistor 23.

In this embodiment, the first transmission line 11 may have any appropriate length, for example a length greater than or equal to a quarter of the wave-length of a signal being divided using the power divider 1.

In this embodiment, the length of each of the second transmission line 12, the third transmission line 13, the fourth transmission line 14, the fifth transmission line 15, the sixth transmission line 16, and the seventh transmission line 17 is substantially equal to a quarter of the wave-length of a signal being divided using the power divider 1.

In this embodiment, each of the resistors 21, 22, 23 is a 100Ω resistor.

In this embodiment, the first input port 2 is electrically connected to a first end of the first transmission line 11.

In this embodiment, a second end of the first transmission line 11 (opposite to the first end of the first transmission line 11) is electrically connected to a first end of the second transmission line 12 and a first end of the third transmission line 13.

In this embodiment a second end of the second transmission line 12 (opposite to the first end of the first transmission line 12) is electrically connected to a first end of the fourth transmission line 14 and a first end of the fifth transmission line 15. Also, the second end of the second transmission line 12 is electrically connected to a first terminal of the first resistor 21.

In this embodiment a second end of the third transmission line 13 (opposite to the first end of the third transmission line 13) is electrically connected to a first end of the sixth transmission line 16 and a first end of the seventh transmission line 17. Also, the second end of the third transmission line 13 is electrically connected to a second terminal of the first resistor 21 (opposite to the first terminal of the first resistor 21).

In this embodiment a second end of the fourth transmission line 14 (opposite to the first end of the fourth transmission line 14) is electrically connected to the first output port 4 and a first terminal of the second resistor 22.

In this embodiment a second end of the fifth transmission line 15 (opposite to the first end of the fifth transmission line 15) is electrically connected to the second output port 6 and a second terminal of the second resistor 22 (opposite to the first terminal of the second resistor 22).

In this embodiment a second end of the sixth transmission line 16 (opposite to the first end of the sixth transmission line 16) is electrically connected to the third output port 8 and a first terminal of the third resistor 23.

In this embodiment a second end of the seventh transmission line 17 (opposite to the first end of the seventh transmission line 17) is electrically connected to the fourth output port 10 and a second terminal of the third resistor 23 (opposite to the first terminal of the third resistor 23).

In operation, an input signal is provided to the power divider 1 at the input port 2. The power divider tends to provide that substantially equal output signals (substantially equal to a quarter of the input signal) are provided at the output ports 4, 6, 8, 10. The output signals have substantially equal phases.

The first resistor 21 tends to provide that the output at the second end of the second transmission line 12 and the output at the second end of the third transmission line 13 are substantially isolated.

The second resistor 22 tends to provide that the output at the second end of the fourth transmission line 14 and the output at the second end of the fifth transmission line 15 are substantially isolated.

The third resistor 23 tends to provide that the output at the second end of the sixth transmission line 16 and the output at the second end of the seventh transmission line 17 are substantially isolated.

The power divider 1 may be used as a power combiner in the conventional way.

The power divider 1 is a two-stage power divider. In this embodiment the second transmission line 12, the third transmission line 13 and the first resistor 21 make up a power divider that forms the first stage of the complete four-way power divider 1. Also, the fourth transmission line 14, the fifth transmission line 15, and the second resistor 22 form a power divider that is in the second stage of the complete four-way power divider 1. Also, the sixth transmission line 16, the seventh transmission line 17, and the third resistor 23 form a power divider that is in the second stage of the complete four-way power divider 1.

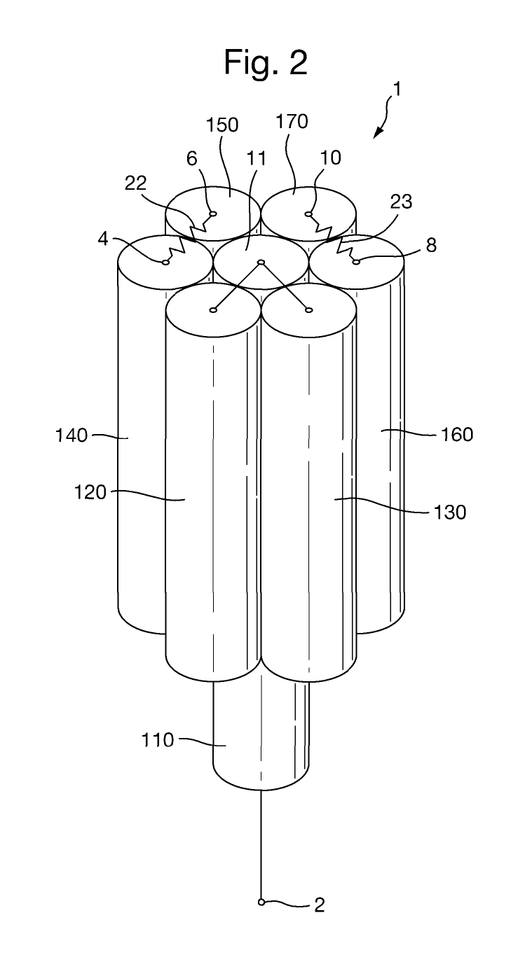

FIG. 2 is a schematic illustration (not to scale) of a perspective view of this embodiment of the power divider 1.

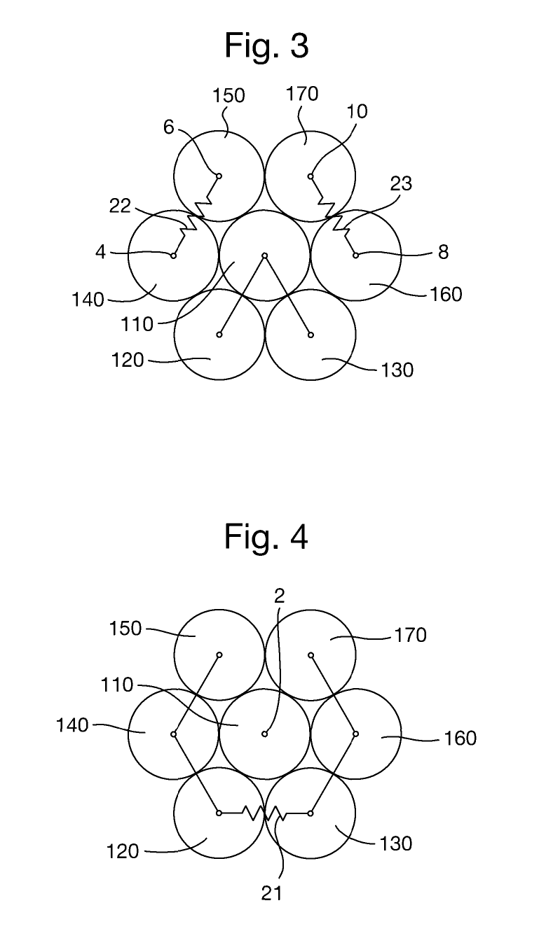

FIG. 3 is a schematic illustration (not to scale) of a top view of this embodiment of the power divider 1, i.e. a view from above of the power divider 1 shown in FIG. 2.

FIG. 4 is a schematic illustration (not to scale) of a bottom view of this embodiment of the power divider 1, i.e. a view from below of the power divider 1 shown in FIG. 2.

In the embodiment shown in FIGS. 2, 3 and 4 each of the transmission lines 11-17 is provided by, i.e. is in the form of, a longitudinal component. In particular, in this embodiment the first transmission line 11 is provided by the first, or initial, longitudinal component 110; the second transmission line 12 is provided by the second longitudinal component 120; the third transmission line 13 is provided by the third longitudinal component 130; the fourth transmission line 14 is provided by the fourth longitudinal component 140; the fifth transmission line 15 is provided by the fifth longitudinal component 150; the sixth transmission line 16 is provided by the sixth longitudinal component 160; and the seventh transmission line 17 is provided by the seventh longitudinal component 170.

In this description, a first end of a longitudinal component corresponds to the first end of the respective transmission line. Likewise, a second end of a longitudinal component corresponds to the second end of the respective transmission line. For example, the first end of the first longitudinal component 110 corresponds to the first end of the first transmission line 11.

In this embodiment, the first longitudinal component 110 is a length of UR67 (RG213/U) coaxial cable having a resistance substantially equal to 50Ω.

In this embodiment, each of the second, third, fourth, fifth, sixth, and seventh longitudinal components 120-170 is a length of UR57 (RG11/U) coaxial cable having a resistance substantially equal to 75Ω.

In this embodiment, the longitudinal components 110-170 are arranged such that the second, third, fourth, fifth, sixth and seventh longitudinal components 120, 130, 140, 150, 160, 170 are positioned around the circumference (i.e. the periphery) of the first longitudinal component 110.

Also, in this embodiment the second, third, fourth, fifth, sixth and seventh longitudinal components 120, 130, 140, 150, 160, 170 are positioned such that the ends of the longitudinal components are at (i.e. aligned with) substantially the same point along the length of the first longitudinal component 110. In particular, in this embodiment the first ends of the second and third longitudinal components 120, 130 are positioned at substantially the same point along the length of the first longitudinal component 110 as the second ends of the third, fourth, fifth, sixth, and seventh longitudinal components 130-170. Also, in this embodiment the second ends of the second and third longitudinal components 120, 130 are positioned at substantially the same point along the length of the first longitudinal component 110 as the first ends of the third, fourth, fifth, sixth, and seventh longitudinal components 130-170.

As such, the bottom end-points of the longitudinal components 120-170 are substantially coplanar and in a plane that is substantially perpendicular to the longitudinal axis defined by the power divider 1. Further, the upper (i.e. output port) end-points of the longitudinal components 110-170 (i.e. including the first longitudinal component) are substantially coplanar and in a plane that is substantially perpendicular to the longitudinal axis defined by the power divider 1.

Also, in this embodiment the longitudinal components 110-170 are positioned such that they are substantially parallel.

In operation, an input signal is provided to the power divider 1 at the input port 2.

This signal travels up (in the orientation of FIG. 2) the power divider 1 along the first longitudinal component 110.

The signal then splits in to two separate signals, and each of these signals travels down (in the orientation of FIG. 2) the power divider 1 along the second longitudinal component 120 (from the first end to the second end) and the third longitudinal component 130 (from the first end to the second end) respectively. The second ends of the second and third longitudinal component 120, 130 are substantially isolated by the first resistor 21 as shown in FIG. 4.

The signal at the second end of the second longitudinal component 120 then splits in to two separate signals. These two signals travel to the first ends of the fourth and fifth longitudinal component 140, 150 respectively.

Also, the signal at the second end of the third longitudinal component 130 then splits in to two separate signals. These two signals travel to the first ends of the sixth and seventh longitudinal component 160, 170 respectively.

The signal at the first end of the fourth longitudinal component 140 travels up (in the orientation of FIG. 2) the power divider 1 along the fourth longitudinal component 140 (from the first end to the second end) to the first output port 4.

Also, the signal at the first end of the fifth longitudinal component 150 travels up (in the orientation of FIG. 2) the power divider 1 along the fifth longitudinal component 150 (from the first end to the second end) to the second output port 6.

The first output port 4 and the second output port 6 are substantially isolated by the second resistor 22 as shown in FIGS. 2 and 3.

The signal at the first end of the sixth longitudinal component 160 travels up (in the orientation of FIG. 2) the power divider 1 along the sixth longitudinal component 160 (from the first end to the second end) to the third output port 8.

Also, the signal at the first end of the seventh longitudinal component 170 travels up (in the orientation of FIG. 2) the power divider 1 along the seventh longitudinal component 170 (from the first end to the second end) to the fourth output port 10.

The third output port 8 and the fourth output port 10 are substantially isolated by the third resistor 23 as shown in FIGS. 2 and 3.

Thus, a four-way power divider 1 is provided.

An advantage provided by the above described power divider is that the power divider is relatively compact (i.e. occupies a relatively small volume, or space) compared to conventional power dividers that are typically planar (i.e. have all of their components arranged in the same plane). The relative compactness of the above described power divider tends to provide space and cost savings.

The relative compactness of the above power divider tends to be provided by “concertinaing”, or “folding”, successive stages of the power divider 1. In other words, the longitudinal components 110-170 that provide the transmission lines 11-17 of the power divider 1 are arranged such that, in operation, the direction of travel of a signal travelling through the longitudinal component/transmission lines of the first stage of the power divider 1 (i.e. the second and third transmission lines 12, 13) is opposite to the direction of travel of a signal through the next (i.e. the second) stage of the power divider 1 (i.e. the fourth, fifth, sixth and seventh transmission line 14-17). In this embodiment, the direction of travel of a signal travelling through the transmission lines of the first stage of the power divider 1 is down (when the power divider is oriented as in FIG. 2), whereas the direction of travel of a signal travelling through the transmission lines of the second stage of the power divider 1 is up (when the power divider is oriented as in FIG. 2).

The concertinaing of the longitudinal component/transmission lines of successive stages of the power divider advantageously tends to facilitate the electrical connection of one stage of the power divider to the next stage of the power divider. For example, the outputs of the first stage of the power divider (i.e. the second ends of the second and third longitudinal components/transmission lines) are relatively close to the inputs of the second stage of the power divider (i.e. the first ends of the fourth, fifth, sixth and seventh longitudinal components/transmission lines). This advantageously tends to provide that the lengths of the electrical connections that connect one stage of the power divider to the next stage of the power divider are relatively small, or substantially minimal. Furthermore, this advantage also tends to be provided by the feature that the second, third, fourth, fifth, sixth and seventh longitudinal components are positioned such that the ends of those longitudinal components are at substantially the same point along the length of the first longitudinal component. The relatively small lengths of electrical connection tend to facilitate manufacture, reduce cost, and increase the reliability of such power dividers.

The relative compactness of the above power divider tends to be provided by collecting, or fixing, the longitudinal components of the power divider into a compact group, i.e. by bunching the longitudinal components together as opposed to positioning the axis of each within a common plane.

The first longitudinal component 110 of the above described power divider 1 advantageously tends to provide a central structure about which the remaining longitudinal components can be arranged. This advantageously tends to provide that the power divider is relatively stable and robust compared to conventional power dividers.

A further advantage provided by the first longitudinal component 110 in the above described embodiment is that an extra “concertina” is introduced. In other words, in operation, prior to being input to the first stage of the power divider, a signal is transmitted through an extra length of transmission cable in a direction opposite to the direction of the signal travelling through the first stage. In this embodiment, this provides that the input port is positioned at the opposite end of the power divider to the output ports. This advantageously tends to facilitate the connection of the power divider within devices. Further, in this embodiment the output ports 4, 6, 8 and 10 are all arranged at the periphery of the divider 1, thereby promoting accessibility e.g. over a divider where outputs must be connected to some of which are at the centre, some of which are at the periphery. Such an provision tends to enable minimal space to be used in making onward electrical connections.

The resistors of the above described power divider tend to advantageously provide isolation between the four output ports, and tend to be sufficiently rated to absorb reflected power at the radiated elements.

The second, third, fourth, fifth, sixth and seventh transmission lines each have a resistance substantially equal to 75Ω. This resistance value tends to be sufficiently close to the value of 50√2Ω (which is the value of the resistance of the second, third, fourth, fifth, sixth and seventh transmission lines which provides that the input is matched when the outputs are terminated in 50Ω). An advantage provided by the 75Ω resistance transmission lines is that transmission lines having this resistance tend to be more readily available and cheaper than transmission lines having resistance equal to 50√2Ω.

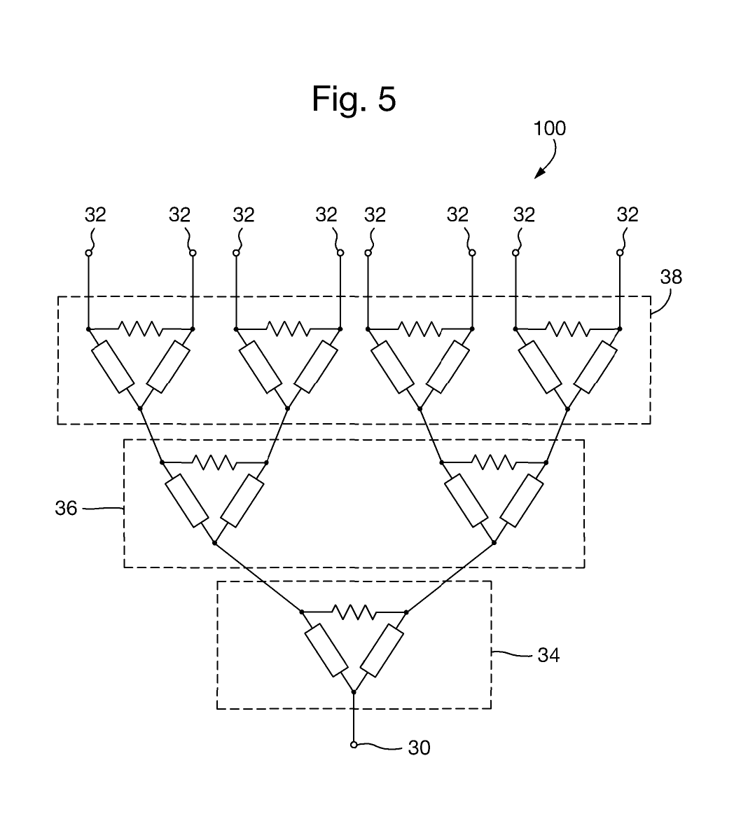

In the above embodiment, the power divider is an equal-amplitude, four-way split, two-stage Wilkinson power divider. However, in other embodiments the power divider is a different type of power divider, e.g. an equal-amplitude, eight-way split, three-stage Wilkinson power divider (as described in more detail later below with reference to FIG. 5).

In the above embodiment, the first longitudinal component is a length of UR67 (RG213/U) coaxial cable having a resistance substantially equal to 50Ω. The first longitudinal component may have any appropriate length. However, in other embodiments the first transmission line may be provided by a different type of component, for example a different type of coaxial cable having a different resistance.

Also, in other embodiments, the power divider does not comprise such a first transmission line/longitudinal component. For example, in a further embodiment, the power divider is an equal-amplitude, eight-way split, three-stage Wilkinson power divider that does not comprise such a first transmission line. This further embodiment will now be described.

FIG. 5 is a schematic circuit diagram (not to scale) of a further embodiment of a power divider, hereinafter referred to as the “further power divider 100”.

In this further embodiment, the further power divider 100 comprises an input port (hereinafter referred to as the “further input port 30”), eight output ports (hereinafter referred to as the “further output ports 32”), a first stage power divider (shown in a dashed box in FIG. 5 and indicated by the reference numeral 34), two second stage power dividers (shown in a dashed box in FIG. 5 and indicated by the reference numeral 36), and four third stage power dividers (shown in a dashed box in FIG. 5 and indicated by the reference numeral 38).

In this further embodiment, longitudinal components that provide the transmission lines of the further power divider 100 are bunched together (in a similar way to that shown in FIG. 2 and described in more detail above) such that the further power divider 100 is relatively compact.

In this further embodiment, when the longitudinal components are positioned in a compact (bunched up) configuration, the further input port 30 is at the bottom of the further power divider 100. A signal input at the further input port 30 travels up the power divider through the transmission lines of the first stage 34 of the further power divider 100. Signals then travel down the power divider through the transmission lines of the second stage 36 of the further power divider 100. Signals then travel up the power divider through the transmission lines of the third stage 38 of the further power divider 100, to the output ports 32.

Thus, the stages 34, 36, 38 of the further power divider 100 are concertinaed in a corresponding way to that described in more detail above with reference to FIG. 2.

Moreover, in the further embodiment, the input port 30 is at an opposite end of the further power divider 100 to the output ports 32 despite there not being a transmission line in the further power divider 100 that corresponds to the first transmission line 11.

In general, if there is an even number of stages in a power divider (e.g. a two-stage, or four-stage power divider), a transmission line corresponding to the above described first transmission line 11 may be used to provide the input port is at an opposite end of the power divider to the output ports. However, if there is an odd number of stages in a power divider (e.g. a three-stage, or five-stage power divider), the concertinaing of the stages of the power divider provides that the input port is at an opposite end of the power divider to the output ports.

As such, in the even-stage embodiment shown in FIGS. 2, 3 and 4, the first transmission line/longitudinal component is used. This provides an “extra concertina” (so as to provide that the input port is at an opposite end of the power divider to the output ports), and also a support structure for positioning the other longitudinal components around. However, in the odd-stage embodiments, such as that of FIG. 5, no such first transmission line is used.

In alternative embodiments, an even-stage embodiment with no first transmission line is used or an odd-stage embodiment with a first transmission line is used. In such alternative embodiments the input ports would tend to be at the same side of the input to the power divider as the output ports. Hence a power divider that need only be accessible from a first end would be provided.

In the embodiment shown in FIGS. 2,3 and 4, each of the second, third, fourth, fifth, sixth, and seventh longitudinal components is a length of UR57 (RG11/U) coaxial cable having a resistance substantially equal to 75Ω. Also, the length of each of the corresponding transmission lines is substantially equal to a quarter of the wave-length of a signal being divided using the power divider. However, in alternative embodiments one or more of the transmission lines is provided by a different type of component, for example a different type of coaxial cable having a different resistance. Also, in other embodiments, one or more of the transmission lines is a different length.

In the above embodiment shown in FIGS. 2, 3, and 4, the second, third, fourth, fifth, sixth and seventh longitudinal components are positioned such that the ends of those longitudinal components are at substantially the same point along the length of the first longitudinal component. However, in alternative embodiments one or more of the longitudinal components are positioned such that its ends are positioned at points along the length of the first longitudinal component that are different to those points at which the ends of other longitudinal components are positioned.

In the above embodiments, each of the resistors is a 1000 resistor. However, in other embodiments one or more of the resistors is a different type of component such that the above described functionality is provided, e.g. a resistor having a different resistance.

In the above embodiments, the stages of the power divider are concertinaed such that, in operation, the direction of travel of a signal through one stage of the power divider is opposite to the direction of travel of a signal through a directly preceding and/or directly subsequent stage. However, in other embodiments some or all stages of the power divider are not concertinaed. For example, in other embodiments, the direction of travel of a signal through each of the stages is the same. However, such a configuration tends to be more difficult to manufacture (e.g. since the outputs of one stage at one end of the power divider have to be connected to the input of the ext stage at the opposite end of the power divider). Nevertheless, the bunching up of the transmission lines tends to provide a space saving compared to conventional power dividers.

1. A power divider/combiner comprising:
a plurality of transmission lines, each transmission line being in the form of a separate longitudinal component;
wherein the longitudinal components are arranged such that they are substantially parallel to each other, and such that a side of each longitudinal component is contiguous with a side of at least one other longitudinal component.

2. A power divider/combiner according to claim 1, wherein each of the transmission lines is of substantially the same length.

3. A power divider/combiner according to claim 2, wherein the length of a transmission line is substantially equal to a quarter of the wavelength of an input signal for the power divider/combiner.

4. A power divider/combiner according to claim 1, wherein the longitudinal components are arranged such that:
one end of each of the longitudinal components is aligned with substantially the same point along a longitudinal axis of the power divider/combiner; and
each of the longitudinal components extends in the same direction along the longitudinal axis of the power divider/combiner from that point.

5. A power divider/combiner according to claim 1, wherein a longitudinal component is a length of coaxial cable.

6. A power divider/combiner according to claim 1, wherein the power divider/combiner is a Wilkinson power divider/coupler.

7. A power divider/combiner comprising:
a plurality of transmission lines, each transmission line being in the form of a separate longitudinal component;
wherein the longitudinal components are arranged such that they are substantially parallel to each other, and such that a side of each longitudinal component is contiguous with a side of at least one other longitudinal component; and wherein the power divider/combiner is a multistage power divider/coupler.

8. A power divider/combiner according to claim 7, wherein the longitudinal components are arranged such that:
a direction of travel of a signal through each of the longitudinal components of one stage of the power divider/combiner is substantially the same; and
the direction of travel of a signal through each of the longitudinal components of one stage of the power divider/combiner is opposite to the direction of travel of the signal through the longitudinal components of a directly preceding and/or directly subsequent stage.

9. A power divider/combiner according to claim 8 further comprising a further longitudinal component, wherein the longitudinal components and the further longitudinal component are arranged such that:
the direction of travel of a signal through the further longitudinal component is opposite to the direction of travel of the signal through the longitudinal components of a directly subsequent stage of the power divider/combiner.

10. A power divider/combiner according to claim 9, wherein a side of each longitudinal component is at least partially contiguous with a side of the further longitudinal component.

11. A power divider/combiner according to claim 9, wherein the further longitudinal component is longer than each of the longitudinal components.

12. A power divider/combiner according to claim 9, wherein the further longitudinal component is a length of coaxial cable.

13. A power divider/combiner comprising:
a plurality of transmission lines, each transmission line being in the form of a separate longitudinal component;
wherein the longitudinal components are arranged such that they are substantially parallel to each other, and such that a side of each longitudinal component is at least partially contiguous with a side of at least one other longitudinal component wherein:
an input port of the power divider/combiner is relatively proximate to an end of at least one of the longitudinal components; and
an output port of the power divider/combiner is relatively proximate to an opposite end of the at least one longitudinal component.

14. A power divider/combiner according to claim 13, wherein one of the longitudinal components is longer than the other longitudinal components.

15. A power divider/combiner according to claim 14, wherein the longer longitudinal component has an end associated with an input port of the divider/combiner.

16. A power divider/combiner according to claim 15, wherein the longer longitudinal component has a length greater than a quarter of the wave-length of a signal receivable at the input port.

17. A power divider/combiner according to claim 16, wherein each of the other longitudinal components has a length substantially equal to a quarter of the wave-length of the signal receivable at the input port.

18. A power divider/combiner according to claim 13, wherein bottom end-points of at least some the longitudinal components are substantially coplanar and in a plane that is substantially perpendicular to a longitudinal axis defined by the power divider/combiner.

19. A power divider/combiner according to claim 18, wherein upper end-points of the longitudinal components are substantially coplanar and in a plane that is substantially perpendicular to the longitudinal axis.

20. A power divider/combiner according to claim 19, wherein the power divider/combiner has a plurality of output ports each proximate to a corresponding one of the upper end-points.
